(19) United States
(12) Patent Application Publication
(10) Pub. No.: US 2012/0224684 A1
(43) Pub. Date: Sep. 6, 2012

(54) SOFT ATTENUATION OF HIGH-POWER SIGNALS

(75) Inventors: Alexander Alexandrovich Petyushko, Bryansk (RU); Dmitry Nikolaevich Babin, Moscow (RU); Alexander Markovic, Media, PA (US); Ivan Leonidovich Mazurenko, Khimki (RU); Denis Vladimirovich Parkhomenko, Moscow (RU)

(73) Assignee: LSI Corporation, Milpitas, CA (US)

(21) Appl. No.: 13/222,132

(22) Filed: Aug. 31, 2011

(30) Foreign Application Priority Data
Mar. 1, 2011 (RU) 2011107922

(51) Int. Cl. H04M 9/08; G06F 17/00

(52) U.S. Cl. 379/406.07; 700/94

(57) ABSTRACT

In one embodiment, a high-level compensation (HLC) module receives samples of an input signal and determines whether a magnitude of each sample, represented in a linear domain, is relatively low or relatively high by comparing the magnitude to a threshold. If a sample is less than or equal to the threshold, then it is considered to have a relatively low magnitude and the sample is not attenuated. If a sample is greater than the threshold, then it is considered to have a relatively high magnitude and the HLC module attenuates the sample according to a “soft” non-linear function. The “soft” non-linear function is characterized by at least two of the following characteristics: the non-linear function (i) increases monotonically, (ii) forms a convex upwards curve, (iii) has a first derivative at the threshold equal to one, and (iv) has a first derivative at a maximum possible magnitude value equal to zero.

### BACKGROUND OF THE INVENTION

1. Field of the Invention

The present invention relates to signal processing, and, more specifically but not exclusively, to techniques for attenuating relatively high-power signals in, for example, telephone communication networks.

2. Description of the Related Art

As used herein, the term “acoustic signal” refers to audible sound, while the term “audio signal” refers to electronic signals, such as the electronic signals generated by a microphone receiving an acoustic signal and the electronic signals converted by a loudspeaker into an acoustic signal. If the term “signal” is used without a qualifying adjective, it should be assumed to refer to an audio signal, not an acoustic signal.

In a telephone network, relatively high-power audio signals may be generated having signal values that are outside the range of values that may be represented digitally by digital processing in the telephone network. Relatively high-power audio signals commonly occur in the use of mobile phones. For example, a relatively high-power audio signal may be generated when a mobile phone user attempts to overcome a relatively high amount of background noise by moving the mobile phone's microphone closer to his or her mouth or speaking louder into the microphone.

When high-power audio signal values outside the range of digital representation are processed by digital processing in the network, the signal values are clipped such that (i) all signal values above the largest positive value that can be represented digitally are truncated to the largest positive value and (ii) all values below the smallest negative value that can be represented digitally are truncated to the smallest negative value. Clipping, which distorts the audio signal and results in decreased voice quality, may occur in various processing modules of the telephone network. For example, clipping may occur in an analog-to-digital converter, a codec, or a voice quality enhancement (VQE) module such as an acoustic echo control module or line echo canceller.

To reduce the effects of clipping in digital processing, high-power audio signals may be attenuated upstream of the digital processing using a high-level compensation (HLC) module. Generally, there are two types of prior-art HLC modules: analog modules implemented in hardware and digital modules implemented in hardware and/or software. There are a relatively large number of prior-art analog HLC modules; however, the number of prior-art digital HLC modules is relatively small. Analog HLC modules are discussed in U.S. Pat. No. 5,128,566 and U.S. Pat. No. 7,110,557, the teachings of both of which are incorporated herein by reference in their entirety. A discussion of prior-art digital HLC modules is found in U.S. Pat. No. 7,110,557.

Typical prior-art digital HLC modules attenuate high-power signals by converting signal levels from a linear domain representation into a logarithmic domain representation, applying threshold logic to the logarithmic domain representation as discussed below in relation to FIG. 1, and converting the possibly attenuated logarithmic domain representation back into a linear domain representation. However, this processing is relatively complex, requires a relatively high consumption of processing power, and results in relatively long delays. Further, use of the threshold logic makes the signal-attenuation transition sharp, which introduces certain artifacts of signal processing. Therefore, there is a need for digital HLC modules having lower complexity and lower delay, and that attenuate signals in a softer manner.

FIG. 1 graphically illustrates the attenuation performed by a prior-art digital HLC module (not shown). The signal input to the HLC module has level magnitude values, which, when represented in a linear domain, range from zero to a maximum possible level magnitude |xₘₐₓ| for the channel, where in this example, |xₘₐₓ| equals one. This range of input level magnitude values is represented on the x-axis of coordinate plane 100 in a logarithmic domain (i.e., dB); however, rather than showing the logarithmic domain equivalent of zero on the x-axis, which is −∞, a minimum input signal level magnitude value dBₘᵢₙ is shown. In this example, a minimum input signal level magnitude value dBₘᵢₙ is set equal to −90, but other values of dBₘᵢₙ may be used. Note that the maximum possible level magnitude |xₘₐₓ| represented in the logarithmic domain (i.e., |x_{max,log}|) is equal to zero. The input signal level magnitude values received by the HLC module may be converted from a linear domain to the logarithmic domain as shown in Equation (1) below:

$${x}_{log} = 20 \times {log}_{10} ( \frac{x}{{x}_{max}} ) = 20 \times {log}_{10} ( x ) - c \qquad ( 1 )$$

where x_{log} is the logarithmic-domain representation of an input signal level magnitude value, x is the linear-domain representation of the input signal level magnitude value, and parameter c equals 20×log₁₀(xₘₐₓ). Note that, in the present example, where xₘₐₓ is equal to one, parameter c is equal to zero. In other embodiments, where xₘₐₓ is not equal to one, c may have a value other than zero.

The signal output by the HLC module has level magnitude values, represented in the same logarithmic domain (i.e., dB), that may range from −90 to a first magnitude threshold Tr1_{log}, where magnitude threshold Tr1_{log} corresponds to the maximum level magnitude that may be represented digitally by digital processing downstream of the HLC module. This range of output level magnitude values is represented on the y-axis of coordinate plane 100.

Attenuation of the input signal levels may be characterized by two linear transfer functions. The first linear transfer function y=m₁x+b₁, where m₁=1 and b₁=0 is plotted as first line segment 104 on coordinate plane 100 between point 102 having coordinates (−90, −90) and point 106 having coordinates (Tr2_{log}, Tr2_{log}), where Tr2_{log} is a second magnitude threshold. The second linear transfer function y=m₂x+b₂, where slope m₂<1 and y-intercept b₂<0, is plotted as second line segment 108 on coordinate plane 100 between point 106 and point 110 having coordinates (|x_{max,log}|, Tr1_{log}).

Input signal level magnitude values that are less than or equal to second level magnitude threshold Tr2_{log} (i.e., relatively low magnitude values) are not attenuated as represented by the first linear function, which corresponds to first line segment 104. As shown, relatively low input signal level magnitude values are not attenuated since slope m₁ of the first linear function equals 1 and y-intercept b₁ equals 0. In other words, relatively low input signal level magnitude values are output from the HLC module unchanged.

Input signal level magnitude values that are greater than the second magnitude threshold Tr2_{log} (i.e., relatively high magnitude values) are attenuated according to the second linear function, which corresponds to second line segment 108. Although the first and second line segments share a common endpoint (i.e., point 106), because the slopes of the two line segments are different, the change in slope at point 106 results in a sharp transition from the absence of attenuation in line segment 104 to the presence of attenuation in line segment 108. Such a sharp transition may degrade the quality of the input signal to an unacceptable level that is unpleasant to the listener.

### SUMMARY OF THE INVENTION

In one embodiment, the present invention is a machine-implemented method for processing a digital input audio signal. The method comprises (a) receiving the digital input audio signal and (b) applying a transfer function to the digital input audio signal to generate a digital output audio signal. The transfer function comprises a non-linear, attenuating portion, such that, when the non-linear, attenuating portion is applied to the digital input audio signal, the digital output audio signal is an attenuated version of the digital input audio signal.

In another embodiment, the present invention is a machine that processes a digital input audio signal. The machine is adapted to (a) receive the digital input audio signal and (b) apply a transfer function to the digital input audio signal to generate a digital output audio signal. The transfer function comprises a non-linear, attenuating portion, such that, when the non-linear, attenuating portion is applied to the digital input audio signal, the digital output audio signal is an attenuated version of the digital input audio signal.

In yet another embodiment, the present invention is a non-transitory machine-readable storage medium, having encoded thereon program code, wherein, when the program code is executed by a machine. The machine implements a method for processing a digital input audio signal, wherein the method comprises (a) receiving the digital input audio signal, and (b) applying a transfer function to the digital input audio signal to generate a digital output audio signal. The transfer function comprises a non-linear, attenuating portion, such that, when the non-linear, attenuating portion is applied to the digital input audio signal, the digital output audio signal is an attenuated version of the digital input audio signal.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 graphically illustrates the attenuation performed by a prior-art digital high-level compensation (HLC) module;

FIG. 2 shows a simplified block diagram of a near end of a telephone network according to one embodiment of the present invention;

FIG. 3 graphically illustrates the attenuation performed by the digital HLC module of FIG. 2 according to one embodiment of the present invention;

FIG. 4 shows Table I, which summarizes six characteristics of the curve in FIG. 3;

FIG. 5 graphically illustrates the attenuation performed by the digital HLC module of FIG. 2 according to another embodiment of the present invention;

FIG. 6 shows Table II, which summarizes six characteristics of the curve in FIG. 5;

FIG. 7 shows a simplified flow diagram of processing that may be performed to determine a “soft” non-linear transfer function for the HLC module of FIG. 2 according to one embodiment of the present invention; and

FIG. 8 shows a simplified data flow diagram of processing performed by the HLC module of FIG. 2 according to one embodiment of the present invention.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

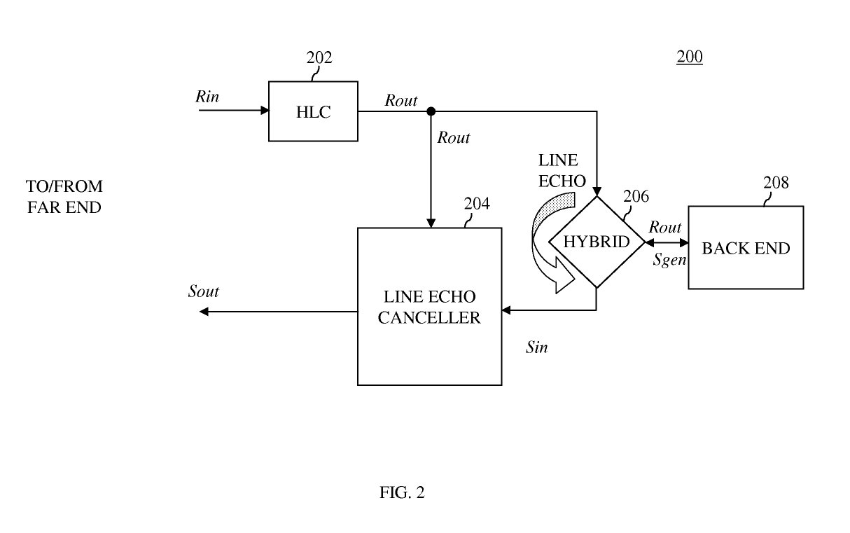

When clipping occurs in a line echo canceller, another problem, other than signal distortion, arises: the difference between the level of speech and the level of the corresponding hybrid echo decreases. To further understand this problem, consider FIG. 2. FIG. 2 shows a simplified block diagram of a near end 200 of a telephone network according to one embodiment of the present invention. A first user located at near end 200 communicates with a second user located at a far end (not shown) of the network. The user at the far end may be, for example, a consumer using a communications device such as wireless phone, or any other device that creates relatively high-power audio signals. The user at near end 200 may be, for example, a consumer using a communications device such as a wireless phone, a wired phone, or any suitable device.

As depicted in FIG. 2, near end 200 has two communication channels: (1) an upper channel for receiving incoming audio signal Rᵢₙ generated at the far end of the network and (2) a lower channel for transmitting outgoing audio signal Sₒᵤₜ to the far end. The far end may be implemented in a manner similar to that of near end 200, rotated by 180 degrees such that the far end receives signals via the lower channel and transmits signals via the upper channel.

Incoming audio signal Rᵢₙ is processed by high-level compensation (HLC) module 202, which attenuates incoming audio signal Rᵢₙ as discussed in further detail below such that all samples of incoming signal Rᵢₙ are within the range of values that may be represented digitally by line echo canceller 204. The processed incoming audio signal Rₒᵤₜ is provided to hybrid 206, which may be implemented as a two-wire-to-four-wire converter that separates the upper and lower channels. Hybrid 206 routes (i) the processed incoming audio signal Rₒᵤₜ to back end 208 for further processing (including rendering by the near end's loudspeaker (not shown)) and (ii) outgoing audio signal S_{gen} received from back end 208 (e.g., corresponding to audio signals generated by the near end's microphone (not shown)) toward the far end. Back end 208, which is part of the near-end user equipment, may include, among other things, the loudspeaker and the microphone of the user equipment.

In routing outgoing audio signal S_{gen} through hybrid 206, unwanted hybrid echo may be combined with outgoing audio signal S_{gen} to generate outgoing audio signal Sᵢₙ having diminished quality. Line echo canceller 204 estimates the hybrid echo in signal Sᵢₙ based on incoming signal and cancels the hybrid echo when doubletalk is not occurring (i.e., when both the near-end user and the far-end user are not both talking at the same time as determined by line echo canceller 204). When doubletalk is occurring, line echo canceller 204 does not cancel hybrid echo because doing so may distort the sounds generated at back end 208 that are represented in outgoing audio signal Sᵢₙ.

Typically, line echo canceller 204 detects the occurrence of doubletalk by considering the level of incoming audio signal the level of outgoing audio signal Sᵢₙ, and the difference in signal levels between incoming audio signal Rₒᵤₜ and outgoing audio signal Sᵢₙ (i.e., the echo return loss (ERL)). When the level of the incoming audio signal is above a first specified level threshold, the level of outgoing audio signal Sᵢₙ is above a second specified level threshold, and the difference in signal levels is greater than a specified difference threshold (i.e., the level of incoming audio signal Rₒᵤₜ is much greater than the level of outgoing audio signal Sᵢₙ), line echo canceller 204 determines that doubletalk is not occurring.

For a moment, suppose that HLC module 202 is not implemented in near end 200. Further, suppose that (i) the incoming audio signal received by line echo canceller 204 and hybrid 206 is a relatively high-power audio signal (i.e., has signal values that are outside the range of values that may be represented digitally by line echo canceller 204) and (ii) doubletalk is not occurring (i.e., audio signals are not being generated at back end 208). In this situation, the incoming audio signal is passed through hybrid 206 without clipping, and hybrid echo represents most, if not all, of outgoing audio signal Sᵢₙ. Outgoing audio signal Sᵢₙ may have a level that is above the second specified level but within the range that may be represented digitally by line echo canceller 204. Therefore, outgoing signal Sᵢₙ is not clipped by line echo canceller 204.

Now suppose that that the incoming audio signal, which has relatively high power, is clipped by line echo canceller 204. Clipping the incoming audio signal but not outgoing audio signal Sᵢₙ results in a decrease in the difference in signal levels between the incoming audio signal and outgoing audio signal Sᵢₙ. If this decrease is significant enough, such that the difference between the incoming and outgoing audio signals is less than the specified difference threshold, then line echo canceller 204 may detect that doubletalk is occurring, even when it is not, and stop cancelling hybrid echo.

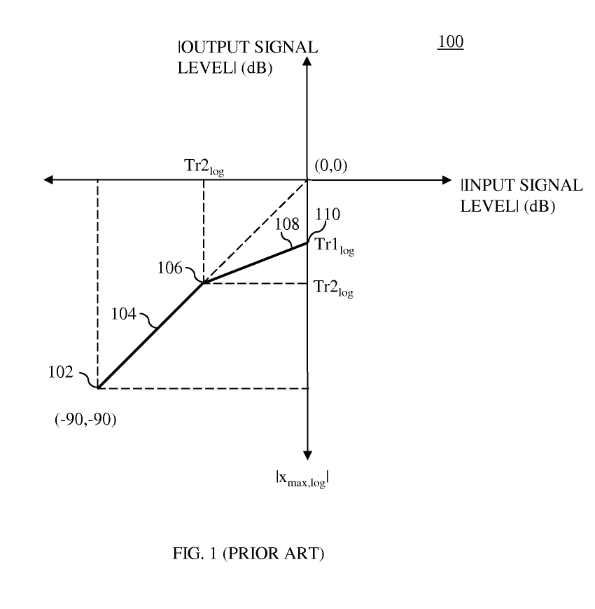

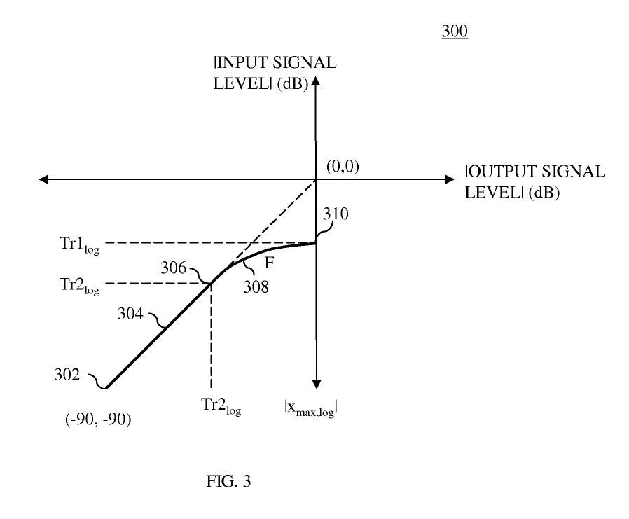

To prevent this adverse effect of clipping (i.e., false detection of doubletalk), HLC module 202 attenuates incoming signal Rᵢₙ such that all samples of incoming signal Rᵢₙ are within the range of values that may be represented digitally by line echo canceller 204. Rather than attenuating samples of incoming signal Rᵢₙ having relatively high level magnitudes (i.e., magnitudes greater than or equal to magnitude threshold Tr2_{log}) according to a linear transfer function similar to that used to generate line segment 108 of FIG. 1, HLC module 202 attenuates relatively high level magnitudes using a “soft,” non-linear transfer function as discussed below in relation to FIG. 3.

FIG. 3 graphically illustrates the attenuation performed by HLC module 202 according to one embodiment of the present invention. In this embodiment, the signal input to HLC module 202 (in this case, incoming signal Rᵢₙ) has level magnitudes, which, when represented in a linear domain, range from 0 to a maximum possible level magnitude |xₘₐₓ| for the channel, where in this example, |xₘₐₓ|=1. This range of input values is represented on the x-axis of coordinate plane 300 in a logarithmic domain (i.e., dB); however, rather than using the logarithm of 0, which is −∞, a minimum level magnitude value dBₘᵢₙ is shown. In this example, minimum input signal level magnitude value dBₘᵢₙ is set equal to −90, but other values of dBₘᵢₙ may be used. Not that the maximum possible level magnitude |x_{max,log}| in the logarithmic domain is equal to 0. The signal output by HLC module 202 (in this case, attenuated incoming signal Rₒᵤₜ) has level magnitude values, represented in the logarithmic domain (i.e., dB), that may range from −90 to a first level magnitude threshold Tr1_{log} as shown on the y-axis of coordinate plane 300, where level magnitude threshold Tr1_{log} corresponds to the maximum level magnitude that may be represented digitally by digital processing downstream of the HLC module.

HLC module 202 does not attenuate relatively low input signal magnitude values (i.e., magnitude values less than or equal to second magnitude threshold Tr2_{log}) as represented by the linear transfer function y=m₃x+b₃, where m₃=1 and b₃=0. The linear function is plotted as first line segment 304 on coordinate plane 300 between point 302 having coordinates (−90, −90) and point 306 having coordinates (Tr2_{log}, Tr2_{log}), where parameter Tr2_{log} is a second magnitude threshold. However, unlike the prior-art HLC module discussed above in relation to FIG. 1, which attenuates relatively high input signal magnitude values according to a second linear transfer function, HLC module 202 attenuates relatively high input signal magnitude values according to a “soft” non-linear transfer function F that is plotted as curve 308 on coordinate plane 300.

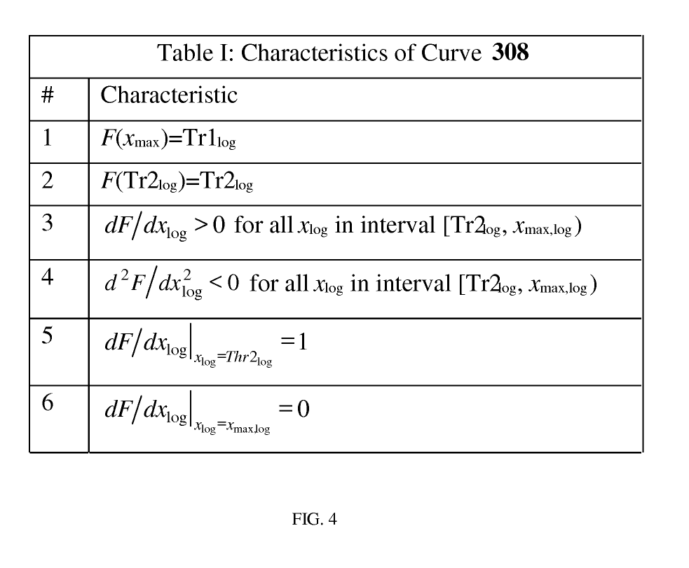

Curve 308 has six characteristics that are of particular interest. FIG. 4 shows Table I, which summarizes these six characteristics. The first and second characteristics define the endpoints of curve 308, and hence are herein referred to as “endpoint conditions.” The third characteristic indicates that curve 308 increases monotonically. The fourth characteristic indicates that curve 308 is a convex upwards curve (i.e., curve 308 has a convex shape when viewed from below the curve). The fifth characteristic indicates that there is a smooth transition from line segment 304 to curve 308. In other words, the slope of the tangent line that may be drawn at point 306 is equal to one (i.e., equal to slope m₃ of line segment 304). The sixth characteristic indicates that the slope of the tangent line that may be drawn at point 310 is equal to zero.

In selecting a suitable non-linear function for implementing the “soft” attenuation of HLC module 202, the curve defined by the selected transfer function should satisfy characteristics #1, #2, and #3 and at least one of characteristics #4 to #6 in Table I (or Table II discussed below). As used herein, the term “soft attenuation” refers to attenuation that is based on a curve that satisfies characteristics #1, #2, and #3 and at least one of characteristics #4 to #6 in Table I (or Table II discussed below). Further, the terms “soft transfer function” and “soft non-linear transfer function” refer to a function that is characterized by a curve that satisfies characteristics #1, #2, and #3 and at least one of characteristics #4 to #6 in Table I (or Table II discussed below). Selection of a suitable non-linear transfer function is discussed in further detail below.

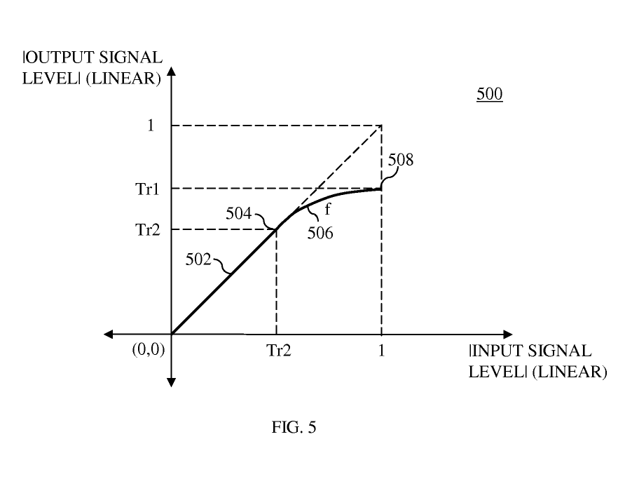

FIG. 5 graphically illustrates the attenuation performed by HLC module 202 according to another embodiment of the present invention. Rather than attenuating input signal level magnitudes that are represented in the logarithmic domain, as is performed in FIG. 3, input signal level magnitudes are attenuated in the linear domain. Performing attenuation in the linear domain eliminates the need to convert the input signal between the linear and logarithmic domains, and, as a result, reduces the complexity of HLC module 202.

As shown on the x-axis of coordinate plane 500, the input signal level magnitude values, represented in the linear domain, range from zero to a maximum possible magnitude value |xₘₐₓ| equal to one. Further, as shown on the y-axis of coordinate plane 500, the output signal level magnitude values, represented in the linear domain, range from zero to a first level magnitude threshold Tr1, which is a linear-domain representation of first magnitude threshold Tr1_{log} of FIG. 3.

A linear transfer function y=m₅x+b₅, where m₅=1 and b=0 characterizes the non-attenuation of relatively low input signal level magnitude values. The linear function is plotted as line segment 502 on coordinate plane 500 between the origin of coordinate plane 500 (i.e., (0, 0)) and point 504 having coordinates (Tr2, Tr2), where Tr2 is a linear-domain representation of second magnitude threshold Tr2_{log} of FIG. 3. Further, relatively high input signal level magnitude values are attenuated according to a non-linear transfer function ƒ, which is the linear-domain representation of non-linear transfer function F in FIG. 3. The non-linear transfer function ƒ is plotted as curve 506 on coordinate plane 500 between point 504 having coordinates (Tr2, Tr2) and point 508 having coordinates (1, Tr1).

Note that, if a monotonically increasing, non-linear transfer function ƒ(x) is selected such that F(x_{log})=g(ƒ(g⁻¹(x))), where g(x) is a function of the transition from linear domain to logarithmic domain (e.g., g(x)=log(x)), g⁻¹(x) is a function of the transition from the logarithmic domain to linear domain (e.g., g⁻¹(x_{log})=exp(x_{log})), and non-linear transfer function F(x_{log}) is a direct image of non-linear transfer function ƒ(x), then transfer function F(x_{log}) will also increase monotonically. Additionally, if non-linear function ƒ(x) forms a convex upwards curve and has a derivative at Tr2_{log} equal to 1, then non-linear transfer function F(x_{log}) will also form a convex upwards curve (i.e., d²F/dx²<0 for all x in interval [Tr2, xₘₐₓ)) and have a derivative at point 504 equal to one (i.e., dF/dx|_{x=Thr2}=1). Therefore, it is possible to perform “soft” attenuation in the linear domain and still achieve the same voice quality as when “soft” attenuation is performed in the logarithmic domain.

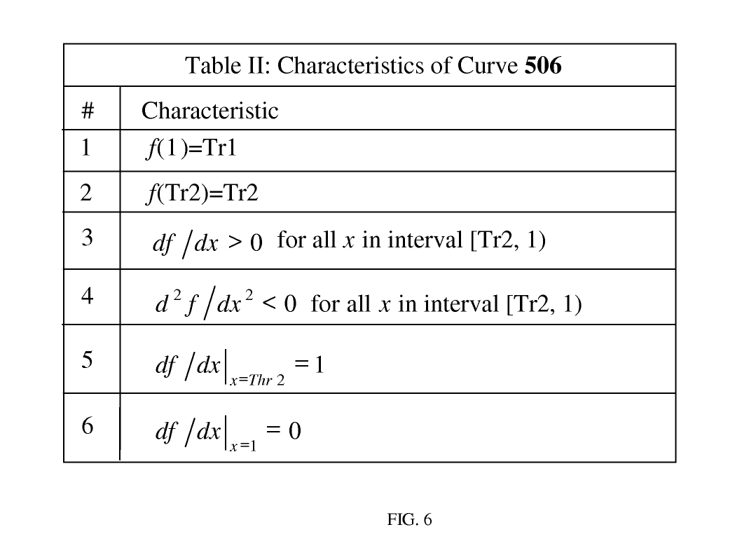

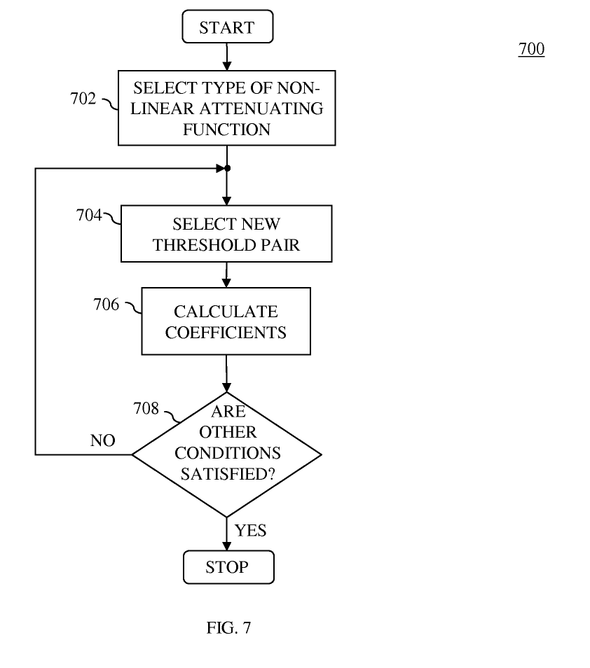

FIG. 6 shows Table II, which summarizes the characteristics of curve 506. Note that these characteristics are equivalent to the characteristics of curve 308 in Table I above with magnitude thresholds Tr1_{log} and Tr2_{log}, function F, and maximum magnitude x_{max,log} represented in the linear domain. There exists a wide range of functions f that satisfy characteristics #1, #2, and #3 and at least one of characteristics #4 to #6 of Table II. For instance, polynomials of degree two or greater can be used to implement curve 506. To further understand how a non-linear transfer function ƒ may be selected to implement curve 506, consider FIG. 7.

FIG. 7 shows a simplified flow diagram 700 of processing that may be performed to determine a “soft” non-linear transfer function for HLC module 202 of FIG. 2 according to one embodiment of the present invention. In step 702, the designer of HLC module 202 selects a type of non-linear function for use in HLC module 202. For example, the designer may select a polynomial of degree two or greater as shown in Equation (2) below:

ƒ(x)=aₙxⁿ+aₙ₋₁xⁿ⁻¹+ . . . +a₁x+a₀ (2)

where n is the degree of the polynomial and the values of coefficients aₙ, aₙ₋₁, . . . , a₀ are unknown. When selecting a polynomial, a relatively low-degree polynomial is preferred because it may be implemented in HLC module 202 with lower complexity than a high-degree polynomial. For ease of explanation, suppose that a quadratic polynomial, where n=2 is selected.

After selecting the type of non-linear function, steps 704 to 708 are performed to determine values for the coefficients (e.g., aₙ, aₙ₋₁, . . . , a₀) that yield a non-linear function in which the two endpoint conditions of Table II and at least two of the four remaining conditions of Table II are satisfied. Steps 704 to 708 may be implemented by a computer executing a suitable computer program.

In step 704, the first and second magnitude thresholds (e.g., Tr1 and Tr2) are selected. These thresholds may be selected, for example, randomly or from a set of specified threshold values. In step 706, the coefficients (e.g., aₙ, aₙ₋₁, . . . , a₀) are calculated based on the first and second magnitude thresholds. The coefficients are calculated based on equations for the coefficients that are determined by solving a system of equations that correspond to three or more of the characteristics in Table II. The system of equations may be selected by the designer based on the desired characteristics of the non-linear transfer function ƒ. For example, suppose that the designer selects a system of equations comprising the equations of the first, second, and fifth characteristics in Table II, where ƒ(x) is a quadratic polynomial as described above. Substituting magnitude thresholds Tr1 and Tr2 into those equations yields Equations (3), (4), and (5) as follows:

a₂Tr2²+a₁Tr2+a₀=Tr2 (3)

a₂+a₁+a₀=Tr1 (4)

2a₂Tr2+a₁=1 (5)

Solving Equations (3) to (5) for coefficients a₂, a₁, and a₀ yields Equations (6), (7), and (8) below:

$$\begin{matrix}{a}_{2} = - \frac{1 - Tr 1}{{( 1 - Tr 2 )}^{2}} & ( 6 ) \\ {a}_{1} = 1 + 2 Tr 2 \frac{1 - Tr 1}{{( 1 - Tr 2 )}^{2}} & ( 7 ) \\ {a}_{0} = - Tr {2}^{2} \frac{1 - Tr 1}{{( 1 - Tr 2 )}^{2}} & ( 8 )\end{matrix}$$

Note that derivation of Equations (6) to (8) may be determined by the designer prior to implementing flow diagram 700 in software, and Equations (6) to (8) may be implemented in software to calculate values for the coefficients in step 706.

Once values for the coefficients have been determined, step 708 is performed to check whether or not one or more of the remaining characteristics in Table II are satisfied. The characteristics that are checked may be selected by the designer. For example, suppose that the designer selects characteristics #3 and #4 to check. The equations corresponding to characteristics #3 and #4 may be represented as shown in Equations (9) and (10), respectively, below:

2a₂x+a₁≧0 for all x in interval [Tr2,1] (9)

2a₂≦0 for all x in interval [Tr2,1] (10)

In this case, it has been determined that characteristics #1 to #5 are not satisfied for all possible pairs of magnitude thresholds (Tr1, Tr2). However, characteristics #1 to #5 are satisfied for a subset of possible pairs (Tr1, Tr2), where 0<Tr2<Tr1<1. From Equation (9), it can be determined that characteristic #3 is satisfied when Tr2≦2Tr1−1. If the selected characteristics are satisfied, then processing is stopped. If the selected characteristics are not satisfied, then step 704 selects a new pair of magnitude thresholds, and steps 706 and 708 are repeated.

As another example, suppose that, instead of selecting a system of equations comprising the equations corresponding to the first, second, and fifth characteristics of Table II as described above, the designer selects a system of equations comprising the equations corresponding to the first, second, and sixth characteristics. The equations corresponding to the first and second characteristics may be represented as shown in Equations (3) and (4) above, and an equation corresponding to the sixth characteristic may be represented as shown in Equation (11) below:

2a₂+a₁=0 (11)

Solving Equations (3), (4), and (11) for coefficients a₂, a₁, and a₀ yields Equations (12), (13), and (14) below:

$$\begin{matrix}{a}_{2} = - \frac{Tr 1 - Tr 2}{{( 1 - Tr 2 )}^{2}} & ( 12 ) \\ {a}_{1} = 2 \frac{Tr 1 - Tr 2}{{( 1 - Tr 2 )}^{2}} & ( 13 ) \\ {a}_{0} = Tr 1 - \frac{Tr 1 - Tr 2}{{( 1 - Tr 2 )}^{2}} & ( 14 )\end{matrix}$$

Similar to Equations (6) to (8), the derivation of Equations (12) to (14) may be determined by the designer prior to implementing flow diagram 700 in software, and Equations (12) to (14) may be implemented in software to calculate values for the coefficients in step 706.

Once values for the coefficients have been calculated using Equations (12) to (14), one or more of the remaining characteristics in Table II are checked in step 708. For example, suppose that the designer selects characteristics #3 and #4 to check, which are represented in Equations (9) and (10) above, respectively. It has been determined that characteristics #1 to #4 and #6 are satisfied for all possible pairs of magnitude thresholds (Tr1, Tr2), where 0<Tr2<Tr1<1.

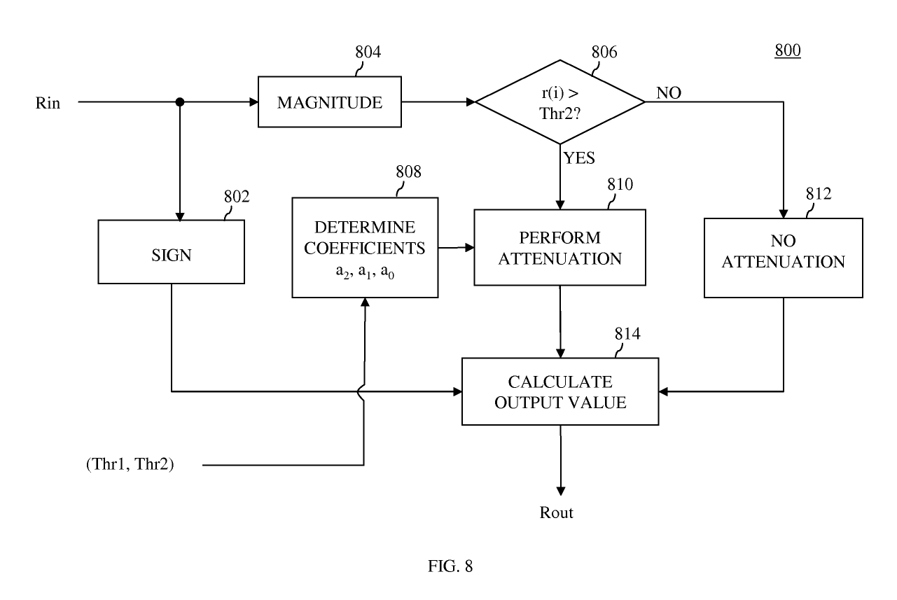

FIG. 8 shows a simplified data flow diagram 800 of processing performed by HLC module 202 of FIG. 2 according to one embodiment of the present invention. In general, HLC module 202 receives samples of incoming signal Rᵢₙ, one sample Rᵢₙ(i) at a time, where i is an index of the sample. HLC module 202 determines whether a magnitude of each sample Rᵢₙ(i), represented in the linear domain, is relatively low or relatively high by comparing the magnitude to a threshold Tr2. If an incoming sample Rᵢₙ(i) has a relatively low magnitude, then HLC module 202 processes the sample according to the linear function discussed above in relation to line 502 of FIG. 5 (i.e., the sample Rᵢₙ(i) is not changed). If an incoming sample Rᵢₙ(i) has a relatively high magnitude, then HLC module 202 attenuates the sample according to a quadratic equation having coefficients a₂, a₁, and a₀ as calculated in Equations (6), (7), and (8) above or Equations (12), (13), and (14) above.

Initially, magnitude thresholds Tr1 and Tr2 are provided to coefficient determination block 808, which determines the values of coefficients a₂, a₁, and a₀ based on magnitude thresholds Tr1 and Tr2. Coefficient determination block 808 may calculate coefficients a₂, a₁, and a₀ using Equations (6), (7), and (8), respectively, or Equations (12), (13), and (14), respectively, upon receiving thresholds values Tr1 and Tr2. Alternatively, coefficients a₂, a₁, and a₀ may be calculated prior to operating HLC module 202 using Equations (6), (7), and (8), respectively, or Equations (12), (13), and (14), respectively, and may be retrieved from memory based on the values of magnitude thresholds Tr1 and Tr2.

Incoming signal Rᵢₙ is provided to sign determination block 802 and magnitude determination block 804, one sample Rᵢₙ(i) at a time. Sign determination block 802 determines the sign of each sample Rᵢₙ(i) as shown in Equation (15) below:

z(i)=sign(Rᵢₙ(i)) (15)

where sign( ) is a function that extracts the sign of Rᵢₙ(i). Magnitude determination block 804 determines the magnitude of each sample Rᵢₙ(i) as shown in Equation (16) below:

r(i)=|Rᵢₙ(i)| (16)

Block 806 compares each magnitude value r(i) to magnitude threshold Tr2. If a magnitude value r(i) is less than or equal to magnitude threshold Tr2 (i.e., r(i) is a relatively low magnitude), then block 812 calculates a non-attenuated magnitude value r₀(i) according to the linear transfer function corresponding to line segment 502 of FIG. 5 (i.e., the sample Rᵢₙ(i) is not changed) as shown in Equation (17):

r₀(i)=r(i) (17)

If a magnitude value r(i) is greater than magnitude threshold Tr2 (i.e., r(i) is a relatively high magnitude), then block 810 calculates an attenuated magnitude value r₀(i) as shown in Equation (18) as follows:

r₀(i)=a₂r(i)²+a₁r(i)+a₀ (18)

Each magnitude value r₀(i) calculated by block 812 and block 810 is provided to block 814, which applies the appropriate sign to the signal Rₒᵤₜ as shown in Equation (19) below:

Rₒᵤₜ(i)=z×r₀(i) (19)

Compared to comparable prior-art digital HLC modules that perform attenuation of magnitude values represented in the logarithmic domain, the HLC module implemented by data flow diagram 800 of FIG. 8 has lower complexity, consumes less processing power, and has a smaller delay. The complexity of data flow diagram 800 may be summarized as follows. Block 810 has a complexity of 2 multiplications and 2 additions (i.e., 2 multiply and accumulate operations). Block 814 has a complexity of 1 multiplication. For an 8 kHz signal, the total complexity is 3*80000.03 million processing cycles per second (MCPS), where the typical number of samples that are attenuated is less than 50%. Such low complexity allows data flow diagram 800 of FIG. 8 to be implemented in a fixed-point processor.

Further, compared to comparable prior-art digital HLC modules that apply linear attenuation to relatively high magnitude values, HLC modules of the present invention may reduce the amount of distortion that results from attenuating relatively high magnitude values.

Although HLC module 202 of FIG. 2 was described as being located at the input of line echo canceller 204, HLC modules of the present invention are not so limited. HLC modules of the present invention may be located at other points in a telephone network. Further, HLC modules of the present invention are not limited to use in telephone networks. In general, HLC modules of the present invention may be used in any suitable application in which a digital signal needs to be attenuated.

Although FIG. 7 and FIG. 8 were described relative to their use with a non-linear function represented in the linear domain, the present invention is not so limited. FIG. 7 and FIG. 8 may also be implemented for non-linear functions represented in the logarithmic domain. In FIG. 7, magnitude thresholds Tr1 and Tr2, maximum magnitude |xₘₐₓ|, and coefficients a₂, a₁, and a₀ would be represented in the logarithmic domain. In FIG. 8, a linear-to-logarithmic domain converter would be located at the input of the data flow diagram such that incoming signal Rᵢₙ is converted into the logarithmic domain, and a logarithmic-to-linear domain converter would be located at the output of the data flow diagram such that resulting signal Rₒᵤₜ is converted into the linear domain.

Further, although the present invention was described as applying a first linear transfer function (e.g., 304, 502) having a slope equal to one to input signal level magnitude values less than a specified threshold (e.g., Tr2_{log}, Tr2) and a non-linear transfer function (e.g., 308, 506) to input signal level magnitude values greater than the specified threshold, the present invention is not so limited. Various embodiments of the present invention may be envisioned in which the linear transfer function has a slope other than one. Further, various embodiments of the present invention may be envisioned that do not apply a linear transfer function to input signal level magnitude values less than a specified threshold, but rather, apply a non-linear transfer function to all input signal level magnitude values. For example, in FIG. 5, rather than applying a linear transfer function corresponding to line segment 502 to input signal level magnitude values less than Tr2, a non-linear transfer function is applied to all input signal level magnitude values, including those less than Tr2, where the non-linear transfer function corresponds to a curve (not shown) that extends between the origin (0, 0) and point 508.

The present invention may be implemented as circuit-based processes, including possible implementation as a single integrated circuit (such as an ASIC, an FPGA, or a digital signal processor), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, general-purpose computer, or other processor.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. The present invention can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing the invention. When implemented on a general-purpose processor or other processor, the program code segments combine with the processor to provide a unique device that operates analogously to specific logic circuits.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A machine-implemented method for processing a digital input audio signal (e.g., Rin), the method comprising:
(a) receiving the digital input audio signal; and
(b) applying a transfer function to the digital input audio signal to generate a digital output audio signal (e.g., Rₒᵤₜ), wherein the transfer function comprises a non-linear, attenuating portion (e.g., 308, 506), such that, when the non-linear, attenuating portion is applied to the digital input audio signal, the digital output audio signal is an attenuated version of the digital input audio signal.

2. The machine-implemented method of claim 1, wherein:
step (a) comprises determining magnitude of the digital input audio signal; and
the transfer function further comprises a linear portion (e.g., 304, 502), wherein:
(i) the linear portion is applied when the magnitude of the digital input audio signal is less than a specified threshold level (e.g., Tr2 log, Tr2); and
(ii) the non-linear portion applied when the magnitude of the digital input audio signal is greater than or equal to the specified threshold level.

3. The machine-implemented method of claim 2, wherein:
the linear portion has a fixed slope; and
the non-linear portion satisfies at least one of first, second, third, and fourth characteristics, wherein:
(1) the first characteristic is a first derivative of the non-linear portion at the specified threshold level being equal to the fixed slope of the linear portion;
(2) the second characteristic is the non-linear portion being monotonically increasing;
(3) the third characteristic is a second derivative of the non-linear portion being always negative; and
(4) the fourth characteristic is a first derivative of the non-linear portion at a maximum possible magnitude level for the digital input audio signal being 0.

4. The machine-implemented method of claim 3, wherein the non-linear portion satisfies at least two of the first, second, third, and fourth characteristics.

5. The machine-implemented method of claim 4, wherein the non-linear portion satisfies at least three of the first, second, third, and fourth characteristics.

6. The machine-implemented method of claim 5, wherein the non-linear portion satisfies all four of the first, second, third, and fourth characteristics.

7. The machine-implemented method of claim 1, wherein the transfer function is defined in a logarithmic domain.

8. The machine-implemented method of claim 1, wherein the transfer function is defined in a linear domain.

9. The machine-implemented method of claim 1, wherein:
the digital input audio signal is an incoming audio signal transmitted from a far end to a near end (e.g., 200) of a communication system; and
further comprising (c) applying the digital output audio signal to an echo canceller (e.g., 204) of the near end, wherein the echo canceller uses the digital output audio signal to cancel echo in an outgoing audio signal (e.g., Sᵢₙ) transmitted from the near end to the far end.

10. The machine-implemented method of claim 9, wherein:
the echo canceller is adapted to detect when to enable and disable echo cancellation; and
applying the transfer function to the digital input audio signal reduces false detections by the echo canceller that result in undesired disabling of the echo cancellation.

11. A machine that processes a digital input audio signal (e.g., Rᵢₙ), the machine adapted to:
(a) receive the digital input audio signal; and
(b) apply a transfer function to the digital input audio signal to generate a digital output audio signal (e.g., Rₒᵤₜ), wherein the transfer function comprises a non-linear, attenuating portion (e.g., 308, 506), such that, when the non-linear, attenuating portion is applied to the digital input audio signal, the digital output audio signal is an attenuated version of the digital input audio signal.

12. The machine of claim 11, wherein:
the machine is adapted to determine magnitude of the digital input audio signal; and
the transfer function further comprises a linear portion (e.g., 304, 502), wherein:
(i) the machine is adapted to apply the linear portion when the magnitude of the digital input audio signal is less than a specified threshold level (e.g., Tr2 log, Tr2); and
(ii) the machine is adapted to apply the non-linear portion when the magnitude of the digital input audio signal is greater than or equal to the specified threshold level.

13. The machine of claim 12, wherein:
the linear portion has a fixed slope; and
the non-linear portion satisfies at least one of first, second, third, and fourth characteristics, wherein:
(1) the first characteristic is a first derivative of the non-linear portion at the specified threshold level being equal to the fixed slope of the linear portion;
(2) the second characteristic is the non-linear portion being monotonically increasing;
(3) the third characteristic is a second derivative of the non-linear portion being always negative; and
(4) the fourth characteristic is a first derivative of the non-linear portion at a maximum possible magnitude level for the digital input audio signal being 0.

14. The machine of claim 13, wherein the non-linear portion satisfies at least two of the first, second, third, and fourth characteristics.

15. The machine of claim 14, wherein the non-linear portion satisfies at least three of the first, second, third, and fourth characteristics.

16. The machine of claim 15, wherein the non-linear portion satisfies all four of the first, second, third, and fourth characteristics.

17. The machine of claim 11, wherein the transfer function is defined in a logarithmic domain.

18. The machine of claim 11, wherein the transfer function is defined in a linear domain.

19. The machine of claim 11, wherein:
the machine is part of a near end (e.g., 200) of a communication system further comprising a far end;
the digital input audio signal is an incoming audio signal transmitted from the far end to the near end of the communication system; and
the near end further comprises an echo canceller (e.g., 204) adapted to use the digital output audio signal to cancel echo in an outgoing audio signal (e.g., Sᵢₙ) transmitted from the near end to the far end.

20. The machine of claim 11, wherein the machine is an integrated circuit.

21. A non-transitory machine-readable storage medium, having encoded thereon program code, wherein, when the program code is executed by a machine, the machine implements a method for processing a digital input audio signal (e.g., Rin), the method comprising:
(a) receiving the digital input audio signal; and
(b) applying a transfer function to the digital input audio signal to generate a digital output audio signal (e.g., Rₒᵤₜ), wherein the transfer function comprises a non-linear, attenuating portion (e.g., 308, 506), such that, when the non-linear, attenuating portion is applied to the digital input audio signal, the digital output audio signal is an attenuated version of the digital input audio signal.
